(19) United States
(12) Patent Application Publication
(10) Pub. No.: US 2015/0050413 A1
(43) Pub. Date: Feb. 19, 2015

(54) BEVERAGES INCLUDING SOLID PARTICULATE MATTER

(71) Applicant: DR PEPPER/SEVEN UP, INC., Plano, TX (US)

(72) Inventors: Adrian M. Sepcic, Frisco, TX (US); Bharani K. Ashokan, McKinney, TX (US); Matthew N. Lecky, Frisco, TX (US); Rein Hirs, Plano, TX (US)

(73) Assignee: DR PEPPER/SEVEN UP, INC., Plano, TX (US)

(21) Appl. No.: 13/970,019

(22) Filed: Aug. 19, 2013

(51) Int. Cl. A23L 2/38; A23C 9/00; A23L 2/02

(52) U.S. Cl. CPC A23L 2/38; A23L 2/02; A23C 9/00
USPC 426/580; 426/590; 426/598; 426/599

(57) ABSTRACT

Beverage products may include an amount of solid material that may include a substantial non-aqueous fraction and may solidify at temperatures of about 25° F. to about 45° F. Particulate matter may include oils and/or a fibrous portion and the particles may provide a perception that the beverage includes crushed ice.

### FIELD

The present application relates to beverages that include solid particulate matter and that may be perceived in a manner similar to beverages that include ice particles. This application further relates to methods of making beverages thereof.

### BACKGROUND

Frozen or partially-frozen beverages, such as slush-type beverages and frozen-carbonated beverages, commonly include a concentration of solutes suitable to depress the freezing point of the beverage to a target temperature. As the freezing point is decreased, water freezes in a more controlled and gradual manner, and rapid or flash freezing, a condition that generally produces beverages of poor quality, may be inhibited. Suitable depression of freezing point has, therefore, been found to be important in the formation of ice crystals of suitable consistency and in providing high-quality, partially-frozen beverages. In full-calorie product versions, sugars are typically present in significant concentrations. For example, many full-calorie, partially-frozen beverages may include greater than about 10 Brix sugars. Within that concentration range, sugar may act to provide a desired level of sweetness and adjust freezing characteristics to provide high-quality beverages.

For reduced-calorie beverages, the concentration of caloric sugar is necessarily decreased, and high-potency sweeteners are typically added to accommodate for a resulting sweetness deficiency. However, high-potency sweeteners may only be suitably added at levels that are inadequate to sufficiently depress the freezing point. Accordingly, the freezing characteristics of reduced-calorie, partially-frozen beverages are less than ideal, and the development of low-calorie products has been hindered. To attempt to address this concern, high-potency sweeteners may be used in combination with other solutes. For example, sugar alcohols may be added to partially-frozen beverages. However, when added at levels sufficient to suitably modify freezing characteristics of a partially-frozen beverage, sugar alcohols may provide undesirable properties including gastrointestinal intolerance. Moreover, some consumers find that beverages that include sugar alcohols are deficient in taste and/or mouthfeel. Other solutes have also been included in partially-frozen beverages, but those solutes have generally been found to negatively impact taste and/or flavor, and the overall quality of the beverages suffers. The production of reduced-calorie, partially-frozen beverages of high quality has not been adequately addressed. Therefore, there is a need for alternative partially-frozen beverage products including particularly those of reduced calories. There is also a need for new partially-frozen beverage products that resemble the consistency and texture typically associated with crushed ice.

### SUMMARY

In some embodiments, a partially-solid beverage product may comprise insoluble material including by way of nonlimiting example silicon dioxide, glass beadlets, encapsulated beadlets, sugar cane fiber, bamboo fiber, fats or oils, hemp, antifoam, or combinations thereof. In some embodiments, at least a portion of the insoluble matter may be configured to solidify at a temperature of between about 25° F. to about 45° F.

In some embodiments, a partially-solid-beverage product may include one or more oils in an amount of about 5% to about 40% by weight, wherein the freezing point of at least one of the oils is between about 28° F. to about 35° F.

### DETAILED DESCRIPTION

The following terms as used herein should be understood to have the indicated meanings

When an item is introduced by “a” or “an,” it should be understood to mean one or more of that item.

The term “beverage” means any drinkable liquid or semi-liquid, including for example flavored water, soft drinks, fruit drinks, slush products, smoothies, coffee-based drinks, tea-based drinks, juice-based drinks, milk-based drinks, dairy compositions, gel drinks, soy-based drinks, protein drinks, carbonated or non-carbonated drinks, and alcoholic or non-alcoholic drinks.

The term “comprises” means includes but is not limited to.

The term “comprising” means including but not limited to.

The term “consumable item” means anything that may be orally ingested by a consumer, including without limitation, a food, beverage, pharmaceutical composition, nutraceutical composition, vitamin, lozenge, dietary supplement, confection, chewing gum, candy, and a combination of any of the foregoing.

The term “having” means including but not limited to.

The term “partially-solid-beverage mix” means any prepared syrup, concentrate, or intermediate composition which may form a beverage that includes a portion of solid particulate matter upon processing by dilution, mixing, addition of gas, whipping, addition to a frozen carbonated beverage or noncarbonated beverage machine, other processing, or combinations of the aforementioned processes.

The term “partially-solid-beverage product” means any partially-solid-beverage mix as well as partially-solid beverages formed thereof.

The term “partially-solid-beverage syrup” means any partially-solid-beverage mix that may be flowable.

The term “ppm” means parts per million by weight.

The term “weighting agent” means a composition that may be added to increase the density of an oil phase in an oil-in-water emulsion. By way of nonlimiting example, weighting agents may include brominated vegetable oil (BVO), sucrose acetate isobutyrate (SAIB), ester gums, glycerol ester of wood rosin, and combinations thereof.

This disclosure is directed to beverages that include solid particulate matter as well as partially-solid-beverage mixes that may be used to make beverages that include solid particulate matter. A partially-solid-beverage mix may, in some embodiments, be added to a machine suitable for making a partially-frozen beverage and may be prepared as either a carbonated or noncarbonated composition. In some embodiments, a partially-solid-beverage mix may include one or more ingredients that upon cooling may solidify and form particulate matter. For example, in some embodiments, a partially-solid-beverage mix may include an oily portion, fibrous portion, or combination of both, and upon cooling to form a beverage at least some of the mix may solidify. In some embodiments, solid particles formed upon cooling a mix may include a significant amount of non-aqueous material, and therefore, a mix may, in some embodiments, solidify at process temperatures outside of the temperature range of freezing commonly associated with other beverages, such as slush type beverages, that include ice crystals.

In some embodiments, at least a portion of particulate solid matter that may be present in a partially-solid beverage may also be present in a partially-solid-beverage mix from which the beverage was prepared. In some embodiments, a beverage including particulate matter may be prepared without the need to solidify particulate matter at or near the time of dispense. A partially-solid-beverage mix that includes particulate matter may, for example, facilitate preparation of frozen-like beverages without the need for complicated machinery. A partially-solid-beverage mix may, in some embodiments, be processed to form a beverage ready for consumption using machinery that may be available at a local convenience store or even at a consumer's home. For example, a beverage that includes particulate matter may be prepared from a partially-solid-beverage mix by mixing, shaking, stirring, or otherwise processing the mix in a manner that may be executable by an end consumer. A mix may be configured such that preparation of a beverage may be accomplished with or without simple dilution. Particulate matter included in a partially-solid beverage mix may be made using any suitable technique for the manufacture of particles including by way of nonlimiting example extrusion, quenching, milling, spray drying, other techniques, and combinations thereof. For example, in some embodiments, particulate matter may be made using extrusion methods, and the extruded material may be rapidly cooled. In some embodiments, extruded material may be quenched to form particles that have a glassy texture. In some embodiments, particulate matter may be configured and/or processed to encourage a significant proportion of a glassy phase or to encourage the production of particles that are highly brittle.

The partially-solid-beverage products described herein may be prepared for consumption as either full-calorie or reduced-calorie beverages. For example, high-quality beverage products may be made over a range of solute concentrations including ranges different from those needed to suitably depress the freezing point of water in current products. Therefore, partially-solid-beverage products herein may be sweetened with a suitable amount of one or more high-potency sweeteners and may not need an amount of added sugars or other solutes. In some embodiments, a partially-solid-beverage product may be non-caloric or may be reduced in calorie content. For example, in some embodiments, a partially-solid beverage may provide less than about 50 calories, less than about 25 calories, or less than about 10 calories for an about 8 to about 10 fluid ounce serving.

Particulate matter may be present in a beverage in sizes and/or concentrations wherein the particulate matter significantly affects the texture, mouthfeel, or other properties of the beverage. In some embodiments, a beverage may further be configured such that a consumer may readily perceive that the particulate matter is present. For example, in some embodiments, the particulate matter may be perceived in a manner that is similar to how one perceives ice particles, and the beverage may be interpreted by a consumer to have mouthfeel and/or textural properties typically associated with beverages that include a proportion of crushed ice. For example, particulate matter may be configured so that a consumer may bite the particles and experience a crunching sensation. Particulate matter may be characterized by any of various properties including by way of nonlimiting example size, shape, hardness, brittleness, heterogeneity, roughness, other properties or combinations thereof. In some embodiments, for any one or combination of more than one of the aforementioned particle properties, solid particles included or made from a partially-solid-beverage mix may be similar to crushed ice. In some embodiments, a partially-solid beverage may include at least two different classes of particles, and the aggregate properties of consuming the particles may provide a perception of crushed ice or crushed ice that is at least in part melting. For example, in some embodiments, solid material present in a partially-solid beverage may be perceived as hard and crunchy or hard and crunchy but with a significant degree of lubricity.

In some embodiments, upon cooling a partially-solid-beverage mix at least a portion of the mix may solidify. A partially-solid-beverage mix or portion of a mix may, for example, be configured to solidify at temperatures between about 25° F. to about 45° F. In some embodiments, a partially-solid-beverage mix may be configured to solidify over a range that includes a temperature that is near yet above a freezing temperature of an aqueous portion of the mix. For example, in some embodiments, a partially-solid-beverage mix may solidify at temperatures between about 32° F. to about 45° F., about 32° F. to about 40° F., or about 32° F. to about 35° F. Particulate matter may, for example, form prior to reaching a temperature where ice crystals may form, and inadvertent flash freezing of a mix may be discouraged. In addition, for a mix configured to solidify near a freezing point of aqueous portions of the mix, an amount of water may become trapped in growing solid regions of particulate matter, and incorporation of some amount of water into particulate matter may improve one or more particle properties including by way of nonlimiting example particle texture, hardness, brittleness, and combinations thereof. In some embodiments, water may be encouraged to freeze along with fibrous portions of a partially-solid-beverage mix. A fibrous portion of a mix may, in some embodiments, include one or more components that may be hydrated or otherwise include an amount of associated water.

In some embodiments, a partially-solid-beverage product may include less than about 25%, about 40%, or about 50% by weight water, and the remainder of the beverage may be non-aqueous. In some embodiments, a partially-solid-beverage product may include less than about 25%, about 40%, or about 50% by weight water and include at least one non-aqueous component that solidifies over a range that encompasses the freezing point of pure water. In some embodiments, a partially-solid-beverage product may solidify over a range that is typical of commercially available frozen-carbonated-beverage machines, but the product may be resistant to flash freezing even if the solute concentration is lower than typically found in a full-calorie-frozen beverage. Therefore, a partially-solid-beverage product may be sweetened with only high-potency or low-calorie sweeteners and without addition of other solutes to adjust the composition's freezing properties. A partially-solid-beverage product may, in some embodiments, include less than about 8 percentage by weight of soluble solutes, less than about 5 percentage by weight of soluble solutes, or less than about 2 percentage by weight of soluble solutes.

In some embodiments, one or more ingredients of a partially-solid-beverage mix or beverage may be insoluble or only partially soluble in water. Ingredients that may be insoluble and which may be present in a partially-solid-beverage product include by way of nonlimiting example silicon dioxide, glass beadlets, encapsulated beadlets, sugar cane fiber, bamboo fiber, fats or oils, hemp, antifoam, or combinations thereof. In some embodiments, insoluble matter in a partially-solid-beverage mix may be dispersed in the form of an emulsion. Alternatively or additionally, in some embodiments, insoluble solid matter in a partially-solid-beverage mix may be included as a suspension. Upon addition of a mix to machinery suitable for production of a partially-frozen beverage, the mix may be cooled and particulate matter may form and/or increase in size. Particulate matter may comprise insoluble matter and may remain present in the partially-frozen beverage for a suitable period of time. As used herein, insoluble material may refer to material that may persist without significant dissolution in a partially-solid beverage for a suitable period of time. For example, insoluble material may dissolve only slowly and remain present for a period of time suitable for consumption. In some embodiments, less than about 25% of solid material present in a partially-solid beverage may dissolve over a period of about 30 minutes.

In some embodiments, a partially-solid-beverage product may include one or more oils. By way of nonlimiting example, a partially-solid-beverage product may include peanut, grapeseed, canola, menthol, mint, spearmint, hempseed, corn, cottonseed oil, another oil, or combinations thereof. In some embodiments, a partially-solid-beverage product may include up to about 40%, up to about 25%, or up to about 10% of one or more oils. In some embodiments, a partially-solid-beverage product may include about 5% to about 40% or about 20% to about 30% of one or more oils.

In some embodiments, an oil may include one or more flavor or fragrance compounds the concentrations of which may depend upon how the oil may be isolated and/or purified. For example, included among fragrance compounds present in some oils are volatile aldehydes or esters, and for some applications that include fragrant oils, care may be taken to avoid removal of the associated fragrance and/or flavoring compounds such as by using suitable milling and/or extraction processes and temperatures. However, in some embodiments of partially-solid-beverage products, an oil may be included at concentrations sufficient to provide an amount of particulate matter appropriate to provide texture and mass, and an oil may be processed to remove one or more volatile compounds that otherwise may interact undesirably or interfere with the perception of other characteristic flavors. For example, in some embodiments, an oil may be processed by methods including for example and without limitation heating, milling, filtration, extraction, supercritical fluid extraction, distillation, other techniques, or combinations thereof in order to remove one or more flavor or fragrance compounds from the oil.

In some embodiments, an oil included in a partially-solid-beverage product may be an edible oil that solidifies at between about 25° F. to about 45° F. In some embodiments, in addition to a first oil, one or more oil-soluble ingredients or additional oils may also be included in a partially-solid-beverage product. An oil-soluble ingredient or combination of oils may, for example, be included in an amount suitable to modify the phase transition properties of a partially-solid-beverage mix. For example, an oil-soluble ingredient may, in some embodiments, be included in an amount suitable to adjust the temperature at which solidification occurs and/or to encourage transition into a glassy solid phase. In some embodiments, up to about 3%, about 5%, or about 10% of menthol or another suitable ingredient or amount may be included in a partially-solid-beverage product. In some embodiments, a partially-solid-beverage product may include about 1% to about 10% menthol.

In some embodiments, a partially-solid-beverage product may include a first oil and a second oil wherein the ratio of the first oil to the second oil may be about 1:10 to about 10:1. In some embodiments, the oils may be included in a partially-solid-beverage mix that is an emulsion, and in some embodiments, a dispersed phase of the emulsion may include both oils. In some embodiments, dispersed regions of an emulsion may, at least in part, remain intact during initial mixing and cooling of a beverage mix and may help to keep the oils in proximity to each other during mixing and cooling stages of beverage production. For example, a shear force associated with stirring blades of a mixing chamber may only partially disrupt dispersed regions of the emulsion. As cooling occurs, the emulsion may help keep oils of individual particles in proximity to each other, and oils in the emulsion may tend to solidify together.

In some embodiments, a temperature range over which a partially-solid-beverage mix solidifies may be broad and may extend over a range that includes temperatures at which more than one oil may solidify. For example, some peanut oils may freeze at between about 34° F. to about 38° F., and some cottonseed oils may freeze at between about 28° F. to about 35° F. In some embodiments, a partially-solid beverage mix may include an oil that freezes within a temperature range of about 35° F. to about 40° F. and another oil that freezes within a temperature range of about 32° F. to about 35° F. In some embodiments, a partially-solid beverage mix may include at least two oils that solidify within and throughout a range of about 32° F. to about 40° F. or about 28° F. to about 35° F. In some embodiments, a partially-solid-beverage mix may include up to about 20% peanut oil and up to about 20% cottonseed oil.

In some embodiments, a partially-solid-beverage product may also include an amount of butter or dairy fats. In some embodiments, a partially-solid-beverage product may include up to about 40%, up to about 25%, or up to about 10% of an amount of butter or dairy fats. In some embodiments, a partially-solid-beverage product may include about 5% to about 40% or about 20% to about 30% of butter or dairy fats.

In some embodiments, a partially-solid-beverage mix may be prepared or processed in the presence of a first amount of water and then diluted to include an amount of water that may be suitable in the beverage as intended for consumption. For example, a mix may be a concentrate and water may be added before addition of the composition to the mixing chamber of a machine suitable for making a partially-frozen beverage. In some embodiments, a partially-solid-beverage mix may be added to a mixing chamber and cooled to initiate the formation of some solid matter. Following the production of at least some solid matter, a second portion of water may be added. Therefore, relative amounts of water and/or other components included in a partially-solid-beverage mix may be the same or different from that in a partially-solid beverage suitable for consumption. In some embodiments, a partially-solid-beverage mix may include up to about 90%, up to about 80%, or up to about 60% of one or more oils, and the mix may be diluted during processing such that a finished beverage may include up to about 40% of one or more oils. An added aqueous portion may or may not be subjected to freezing conditions following the addition.

In some embodiments, a partially-solid-beverage product may include a fibrous portion. For example, a partially-solid-beverage product may include up to about 50%, up to about 40%, or up to about 25% of a fibrous portion. In some embodiments, a partially-solid-beverage product may include about 5% to about 50% or about 15% to about 35% of a fibrous portion. In some embodiments, a partially-solid-beverage mix may include up to about 90%, up to about 80%, or up to about 60% of one or more oils, and the mix may be diluted during processing such that a finished beverage may include up to about 50% fiber. A fibrous portion of a partially-solid-beverage product may, in some embodiments, solidify at temperatures between about 25° F. to about 45° F. In some embodiments, a fibrous portion of a partially-solid-beverage mix may solidify at temperatures between about 32° F. to about 45° F., about 32° F. to about 40° F., or about 32° F. to about 35° F. In some embodiments, a fibrous portion of a partially-solid-beverage mix may solidify at temperatures between about 28° F. to about 35° F.

A fibrous portion of a partially-solid-beverage product may by way of nonlimiting example include sugar cane fiber, bamboo fiber, another source of fiber or combinations thereof. Fibrous portions may comprise any suitable ratio of various fibrous materials including by way of nonlimiting example cellulose, hemicellulose, lignin, pectin, chitin, gums, beta-glucan, resistant starches, other materials and combinations thereof. A fibrous portion may include soluble matter, insoluble matter or a combination of both. In some embodiments, a fibrous material may include an amount of insoluble matter that is greater than about 50%, about 75%, or about 85% by mass with respect to the total amount of added fiber in a beverage. In some embodiments, a fibrous portion may include a hemicellulosic portion. For example, in some embodiments, fiber may be selected or processed to include greater than about 25%, greater than about 35%, or greater than about 50% of hemicelluloses. A fibrous portion may be selected or processed to increase the tendency of the material to solidify into particles that may be brittle and or that provide a crunchy texture when consumed.

In some embodiments, a partially-solid-beverage product may include a combination of more than one non-aqueous ingredient configured to form particulate matter. For example, a partially-solid beverage product may include a fibrous portion and a portion of one or more oils. In some embodiments, a partially-soluble beverage mix may be cooled and may reach a first transition temperature wherein a first non-aqueous portion may begin to solidify. Upon further cooling, a mix may reach one or more other transition temperatures, and one or more other non-aqueous portions may solidify. The transition temperatures and included amounts of different portions of a mix may be configured such that a mix may solidify at a desired rate. In some embodiments, a combination of different portions of non-aqueous materials may facilitate the production of partially-solid beverages that include a desired set of properties including for example taste, mouthfeel, texture, gastrointestinal tolerance or combinations thereof. In addition, partially-solid beverages may possess a desired set of properties without requiring a substantial amount of added water. For example, the beverages may include a high proportion of solids and the thickness of a partially-solid beverage may be suited for the preference of some consumers. In some embodiments, non-aqueous portions of a partially-solid-beverage may include up to about 50%, up to about 60%, or up to about 80% by weight of a total beverage mass.

In some embodiments, non-aqueous portions of a partially-solid-beverage may include a combination of one or more oils and one or more other non-aqueous portions selected from the group of materials including by way of nonlimiting example fiber, silicon dioxide, glass beadlets, encapsulated beadlets, hemp, and antifoam. For example, a partially-solid beverage mix may include up to about 40% of one or more oils and include one or more other non-aqueous materials. In some embodiments, at least a portion of the non-aqueous materials may be present in solid form in the mix. Solid matter already present in the mix may be configured to be hard, brittle and/or crunchy, and forming other solid material during cooling may help support the matter in an evenly distributed manner in a formed beverage. For example, oils may be included in a mix and may solidify upon processing in suitable machinery for making a partially-frozen beverage, as oily particulate matter forms the material may support and/or provide a degree of lubricity to other solid particulate matter that may provide texture, crunchiness, or provide another property to the beverage. In some embodiments, a partially-solid beverage product may include up to about 40% of one or more oils and include up to about 10% of either glass or encapsulated beadlets.

In some embodiments, non-aqueous portions of a partially-solid-beverage may include a combination of fiber and one or more other non-aqueous portions selected from the group of materials including by way of nonlimiting example one or more oils, silicon dioxide, glass beadlets, encapsulated beadlets, hemp, and antifoam.

In some embodiments, a partially-solid-beverage product may be an emulsion. An emulsion may incorporate a reagent that improves its stability. Reagents that improve the stability of emulsions may, for example, be emulsifiers and may be referred to herein as “stabilizing agents” or “stabilizers.” Representative stabilizing agents may include, for example, yucca schidigera extracts, quillaja extracts, Labiatae herb extracts, carnosic acid, esters of carnosic acid (including methyl carnosate and ethyl carnosate), carnosol, rosmariquinone, rosmanol, epi-rosmanol, isorosmanol, rosmaridiphenol, 12-methoxycaniosic acid, Sophora japonica saponin, enzyme-treated lecithins, enzyme-digested lecithins, plant sterols, plant lecithins, sphingolipids, soybean saponin, bile powder, animal sterols, tomato glucolipids, fractionated lecithins, barley husk extract, enzyme-treated soybean saponin extract, tea seed saponin, beet saponin, propylene glycol fatty acid esters, sarsaparilla extracts, sorbitan fatty acid esters, sucrose fatty acid esters, and mixtures thereof. In some embodiments, yucca schidigera extract, quillaja extract or a combination of both may be included in a partially-solid beverage product. In some embodiments, a partially-solid beverage product may include one or more emulsion stabilizing agents and may further include a weighting agent. For example, in some embodiments, a partially-solid-beverage product may include a weighting agent selected from the group of brominated vegetable oil (BVO), sucrose acetate isobutyrate (SAIB), ester gums, glycerol ester of wood rosin, and combinations thereof.

A stabilizing agent may, in some embodiments, include a proportion of added water in addition to active portions of the agent. For example, quillaja extract can be obtained from Ingredion Inc. (Westchester, Ill.) as a dilute solution under the trade name Q-Naturale™ (hereafter, “Q-Naturale”). In addition to any added water, a quillaja extract may comprise an active portion of surfactants the majority of which may comprise saponins. An active portion of a quillaja extract may herein be referred to as a surfactant portion of the extract. In some embodiments, a ratio of oils to a surfactant portion of a quillaja extract by weight may be about 8:1 to about 2.5:1, or about 5:1 to about 3:1 in a partially-solid-beverage mix. In some embodiments, a stabilizing agent may include about equal parts of both a quillaja extract and yucca schidigera extract.

In some embodiments, a partially-solid-beverage mix may be configured such that it may be packaged and handled as syrup. That is, a mix may be a flowable composition. In some embodiments, an emulsion may help maintain the syrup in a form where bulk separation of portions of the syrup may be inhibited and the syrup may be poured or otherwise added in a repeatable manner to machinery suitable for making a partially-frozen beverage. A partially-solid beverage syrup may be configured and/or settings on machinery suitable for making a partially-frozen beverage may be adjusted to encourage a desired degree of disruption of a dispersed phase of an emulsion. The emulsion may remain substantially intact during mixing and at least initial cooling stages in the production of a partially-solid beverage. Therefore, during beverage production, bulk separation of oil from other components of a syrup may not be a concern and overall beverage consistency and quality may be improved. Furthermore, as the temperature is dropped, molecules in a dispersed phase region may remain together and solidification may thereby be encouraged.

In some embodiments, a partially-solid-beverage product may further include a foaming agent. In some embodiments, reagents that stabilize a beverage mix as an emulsion may also serve to promote foam formation in the prepared beverage. In some embodiments, a foaming agent may comprise yucca schigidera extract, quillaja extract or a combination of both. In some embodiments, a surfactant may act both to maintain a beverage mix as an emulsion and also may serve as a foaming agent.

In some embodiments, a consumable composition may include additives such as caffeine, coloring agents (“colorants,” “colorings”), emulsifiers, food-grade acids, minerals, micronutrients, plant extracts, preservatives, salts (including buffering salts), stabilizers, thickening agents, medicaments, and a combination comprising any of the foregoing. Those of ordinary skill in the art will understand that certain additives may meet the definition or function according to more than one of the above-listed additive categories.

Exemplary salts may include alkali or alkaline earth metal chlorides, glutamates, and the like. For example, monosodium glutamate, potassium chloride, sodium chloride, and a combination comprising any of the foregoing salts may be used. The salts may be added to the beverage as a flavor potentiator as described above. Food-grade acids for use in certain embodiments of the consumable composition may include, for example, acetic acid, adipic acid, ascorbic acid, butyric acid, citric acid, formic acid, fumaric acid, glyconic acid, lactic acid, malic acid, phosphoric acid, oxalic acid, succinic acid, tartaric acid, and a combination comprising any of the foregoing food-grade acids. The food-grade acid may be added as acidulant to control the pH of the consumable composition and also to provide some preservative properties; or to stabilize the consumable composition. The pH of a beverage, syrup or mix, or concentrate may also be modified by the addition of food-grade compounds such as ammonium hydroxide, sodium carbonate, potassium carbonate, sodium bicarbonate, and the like, and a combination comprising any of the foregoing. Additionally, the pH may be adjusted by the addition of carbon dioxide. The pH may also affect the relative partition of solutes between liquid and solid portions of a beverage; such is particularly true if the pH is changed over a region where a solute becomes at least fractionally ionized. In some embodiments, the ionization of a component may be modified by selection of a pH that alters the fraction of a component which is ionized. In addition, a sweetener or bulk solute may in some cases be selected because within a desired pH range for a beverage, the component may exist in an ionized form.

A person having ordinary skill in the art will understand that embodiments of beverages may contain one or more flavors. Exemplary flavor oils may include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil; useful flavoring agents may include artificial, natural and synthetic fruit flavors such as vanilla, and citrus oils including lemon, orange, lime, grapefruit, yazu, sudachi, and fruit essences including apple, pear, peach, grape, blueberry, strawberry, raspberry, cherry, plum, prune, raisin, cola, guarana, neroli, pineapple, apricot, banana, melon, apricot, ume, cherry, raspberry, blackberry, tropical fruit, mango, mangosteen, pomegranate, papaya and so forth. Additional exemplary flavors imparted by a flavoring agent may include a milk flavor, a butter flavor, a cheese flavor, a cream flavor, and a yogurt flavor; a vanilla flavor; tea or coffee flavors, such as a green tea flavor, an oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a camomile flavor, a mustard flavor, a cardamon flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; a nut flavor such as an almond flavor, a hazelnut flavor, a macadamia nut flavor, a peanut flavor, a pecan flavor, a pistachio flavor, and a walnut flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor.

In some embodiments, other flavoring agents may include aldehydes and esters such as cinnamyl acetate, cinnamaldehyde, citral diethylacetal, dihydrocarvyl acetate, eugenyl formate, p methylamisol, and so forth. Examples of aldehyde flavorings may include acetaldehyde (apple), benzaldehyde (cherry, almond), anisic aldehyde (licorice, anise), cinnamic aldehyde (cinnamon), citral, i.e., alpha citral (lemon, lime), neral, i.e., beta citral (lemon, lime), decanal (orange, lemon), ethyl vanillin (vanilla, cream), heliotrope, i.e., piperonal (vanilla, cream), vanillin (vanilla, cream), alpha amyl cinnamaldehyde (spicy fruity flavors), butyraldehyde (butter, cheese), valeraldehyde (butter, cheese), citronellal (modifies, many types), decanal (citrus fruits), aldehyde C 8 (citrus fruits), aldehyde C 9 (citrus fruits), aldehyde C 12 (citrus fruits), 2 ethyl butyraldehyde (berry fruits), hexenal, i.e., trans 2 (berry fruits), tolyl aldehyde (cherry, almond), veratraldehyde (vanilla), 2,6 dimethyl 5 heptenal, i.e., melonal (melon), 2,6 dimethyloctanal (green fruit), and 2 dodecenal (citrus, mandarin), and the like.

The flavoring agents may be used in liquid or solid/dried form and may be used individually or in a mixture. When employed in dried form, suitable drying means such as spray drying an oil may be used. Alternatively, the flavoring agent may be absorbed onto water-soluble materials, such as cellulose, starch, sugar, maltodextrin, gum arabic and so forth or may be encapsulated. In still other embodiments, the flavoring agent may be adsorbed onto silicas, zeolites, and the like. The techniques for preparing such dried forms are well-known.

In some embodiments, the flavoring agents may be used in many distinct physical forms. Without being limited thereto, such physical forms may include free forms, such as spray dried, powdered, beaded forms, encapsulated forms, emulsions such as caramel or gum arabic emulsions, and a combination comprising at least one of the foregoing physical forms. The particular amount of the flavoring agent effective for imparting flavor characteristics to the composition may depend upon several factors including the flavor, the flavor impression, and the like.

In some embodiments, the tartness of a beverage may be varied by selecting and combining acids to provide a desired tartness perception. Some factors to consider in determining a desired tartness include, for example, the acid's dissociation constant, solubility, pH, etc. These variables may be measured by measuring the titratable acidity of a beverage, syrup or mix, or concentrate.

In some embodiments, a coloring agent may be used in amounts effective to produce a desired color for the composition. Exemplary coloring agents may include pigments, natural food colors and dyes suitable for food, drug and cosmetic applications. A full recitation of all colorants approved by the United States Food and Drug Administration, together with corresponding chemical structures, may be found in the Kirk-Othmer Encyclopedia of Chemical Technology, 3rd Edition, in volume 5 at pages 857-884.

As classified by the United States Food, Drug, and Cosmetic Act (21 U.S.C. §301 et seq.), colors may include those exempt from certification colors (sometimes referred to as natural even though they can be synthetically manufactured) and certified colors (sometimes referred to as artificial), and a combination comprising any of the foregoing. In some embodiments, exemplary colors exempt from certification or natural colors may include, for example, annatto extract, (E160b), bixin, norbixin, astaxanthin, dehydrated beets (beet powder), beetroot red/betanin (E162), ultramarine blue, canthaxanthin (E161g), cryptoxanthin (E161c), rubixanthin (E161d), violanxanthin (E161e), rhodoxanthin (E161f), caramel (E150(a-d)), β-apo-8′-carotenal (E160e), β-carotene (E160a), alpha carotene, gamma carotene, ethyl ester of beta-apo-8 carotenal (E160f), flavoxanthin (E161a), lutein (E161b), cochineal extract (E120); carmine (E132), carmoisine/azorubine (E122), sodium copper chlorophyllin (E141), chlorophyll (E140), toasted partially defatted cooked cottonseed flour, ferrous gluconate, ferrous lactate, grape color extract, grape skin extract (enocianina), anthocyanins (E163), haematococcus algae meal, synthetic iron oxide, iron oxides and hydroxides (E172), fruit juice, vegetable juice, dried algae meal, tagetes (Aztec marigold) meal and extract, carrot oil, corn endosperm oil, paprika, paprika oleoresin, phaffia yeast, riboflavin (E101), saffron, titanium dioxide, turmeric (E100), turmeric oleoresin, amaranth (E123), capsanthin/capsorbin (E160c), lycopene (E160d), and a combination comprising any of the foregoing.

In some embodiments, exemplary certified colors may include FD&C blue #1, FD&C blue #2, FD&C green #3, FD&C red #3, FD&C red #40, FD&C yellow #5 and FD&C yellow #6, tartrazine (E102), quinoline yellow (E104), sunset yellow (E110), ponceau (E124), erythrosine (E127), patent blue V (E131), titanium dioxide (E171), aluminum (E173), silver (E174), gold (E175), pigment rubine/lithol rubine BK (E180), calcium carbonate (E170), carbon black (E153), black PN/brilliant black BN (E151), green S/acid brilliant green BS (E142), and a combination comprising any of the foregoing. In some embodiments, certified colors may include FD&C aluminum lakes, which consist of the aluminum salts of FD&C dyes extended on an insoluble substrate of alumina hydrate. Additionally, in some embodiments, certified colors may be included as calcium salts.

In some embodiments, a consumable composition may include additional preservatives to provide freshness and to prevent the unwanted growth of bacteria, molds, fungi, or yeast. The addition of a preservative, including antioxidants, may also be used to maintain the composition's color, flavor, or texture. Exemplary preservatives may include benzoic acid alkali metal salts (e.g., sodium benzoate), sorbic acid alkali metal salts (e.g., potassium sorbate), ascorbic acid (Vitamin C), citric acid, calcium propionate, sodium erythorbate, sodium nitrite, calcium sorbate, butylated hydroxyanisole (BHA), butylated hydroxytoluene (BHT), ethylenediaminetetraacetic acid (EDTA), tocopherols (Vitamin E), straight chain polyphosphates, and a combination comprising any of the foregoing preservatives.

Unless otherwise noted, where reference is made to a percentage of something in a given composition it should be interpreted to be a percentage by weight. While many examples in this description refer to compositions and methods of making compositions, it is understood that those compositions and methods are described in an exemplary manner only and that other compositions and methods may be used. For example, any feature described for one embodiment may be used in any other embodiment. Additionally, other ingredients may be used, depending on the particular needs. Although the foregoing specific details describe certain embodiments, persons of ordinary skill in the art will recognize that various changes may be made in the details of these embodiments without departing from the spirit and scope of this invention as defined in the appended claims and other claims to be drawn to this invention, considering the doctrine of equivalents. Therefore, it should be understood that this invention is not limited to the specific details shown and described herein.

What is claimed is:

1. A partially-solid-beverage product comprising:
one or more oils in an amount of about 5% to about 40% by weight;
wherein the freezing point of at least one of said oils is between about 25° F. to about 45° F.

2. The beverage product of claim 1 wherein the freezing point of at least one of said oils is between about 32° F. to about 35° F.

3. The beverage product of claim 1 wherein the freezing point of at least one of said oils is between about 28° F. to about 35° F.

4. The beverage product of claim 1 wherein the beverage product solidifies at between about 32° F. to about 40° F.

5. The beverage product of claim 1 wherein the beverage product solidifies at between about 28° F. to about 35° F.

6. The beverage product of claim 5 wherein the weight percentage of soluble solutes is less than about 5% by weight.

7. The beverage product of claim 5 wherein the water content of said beverage product is less than about 50% by weight.

8. The beverage product of claim 1 wherein said one or more oils include a first oil that freezes within a temperature range of about 35° F. to about 40° F. and a second oil that freezes within a temperature range of about 32° F. to about 35° F.

9. The beverage product of claim 1 wherein said beverage product is a reduced-calorie, partially-frozen beverage or non-caloric, partially-frozen beverage.

10. The beverage product of claim 9 wherein said beverage product provides less than about 50 calories for an about 8 to 10 ounce serving.

11. The beverage product of claim 1 wherein said one or more oils are selected from the group consisting of peanut, grapeseed, canola, mint, menthol, spearmint, hempseed, corn, cottonseed, and combinations thereof.

12. The beverage product of claim 1 wherein said one or more oils are included at about 20% to about 30% by weight.

13. The beverage product of claim 1 wherein said one or more oils include up to about 20% peanut oil by weight and up to about 20% cottonseed oil by weight.

14. The beverage product of claim 1 further comprising up to about 10% by weight glass beadlets or encapsulated beadlets.

15. The beverage product of claim 1 further comprising an emulsion stabilizing agent selected from the group consisting of quillaja extracts, yucca schidigera extracts, and a combination of both quillaja and yucca schidigera extracts.

16. The beverage product of claim 1 further comprising up to about 25% by weight butter or dairy fats.

17. The beverage product of claim 1 further comprising about 1% to about 10% menthol.

18. A beverage product comprising:
a fibrous portion in an amount of about 5% to about 50% by weight;
wherein said fibrous portion solidifies at between about 28° F. to about 35° F.

19. The beverage product of claim 18 further comprising at least one oil in an amount up to about 40% by weight.

20. The beverage product of claim 18 further comprising less than about 40% water by weight.
